(19) United States
(12) Patent Application Publication
(10) Pub. No.: US 2026/0368599 A1
(43) Pub. Date: Nov. 19, 2026

(54) QUANTUM COMPUTING FOR ACCELERATING MACHINE LEARNING MODEL TRAINING

(71) Applicants: Research Foundation of the City University of New York, New York, NY (US); Rensselaer Polytechnic Institute, Troy, NY (US)

(72) Inventors: German Kolmakov, Bellarose, NY (US); Yuri Lvov, Troy, NY (US); Shaina Raklyar, Brooklyn, NY (US)

(21) Appl. No.: 18/758,766

(22) Filed: Jun. 28, 2024

Related U.S. Application Data
(60) Provisional application No. 63/614,847, filed on Dec. 26, 2023.

(51) Int. Cl. G06N 10/60; G06N 3/08

(52) U.S. Cl. CPC G06N 10/60; G06N 3/08

(57) ABSTRACT

A system and method to accelerate machine learning training comprises receiving, by a non-quantum computer, a set of data for training a machine learning model; dividing the set of data into a plurality of data batches, each data batch determined according to predetermined requirements of a quantum computer; calculating, by the non-quantum computer, a Jacobian matrix for each of the plurality of data batches, the Jacobian matrix and a loss vector being part of a linear matrix equation for updating weights in the model; arranging, by the non-quantum computer, input data of a polynomial function formatted for a quantum computer; solving, by the quantum computer, a vector of weight updates; and updating the weights in the model.

### RELATED APPLICATIONS

This application claims priority to U.S. Provisional Application Ser. No. 63/614,847 filed Dec. 26, 2023, entitled “METHOD TO ACCELERATE MACHINE LEARNING MODEL TRAINING BY USING QUANTUM COMPUTING,” the entirety of which is incorporated by reference herein.

### STATEMENT REGARDING FEDERALLY FUNDED RESEARCH OR DEVELOPMENT

This invention was made with government support under grant number NSF TIP 2141058 entitled “PFI-TT: Prototyping a quantum-powered AI building platform” awarded by the National Science Foundation. The government has certain rights in the invention.

### FIELD

The present concepts relate to the implementation of quantum computing for accelerating processes implemented and executed by machine learning and artificial intelligence systems.

### BACKGROUND

A fully functional Artificial Intelligence (AI) and machine learning (ML) implementation (generally “AI/ML”) has the potential to be transformative by advancing science and technology, by stimulating advances in chemistry creating new materials and new drags, revolutionizing manufacturing and retail, reducing risks in high-tech, exploration and mission planning, and improving decision making in governmental, banking and healthcare economy sectors. With AI/ML, a significant part of decision-making tasks can be automated to reduce human errors thereby reducing mission failure risks.

### SUMMARY

In an aspect of the present inventive concept, a method to accelerate machine learning training comprises receiving, by a non-quantum computer, a set of data for training a machine learning model; dividing the set of data into a plurality of data batches, each data batch determined according to predetermined requirements of a quantum computer; calculating, by the non-quantum computer, a Jacobian matrix for each of the plurality of data batches, the Jacobian matrix and a loss vector being part of a linear matrix equation for updating a weight in the model; arranging, by the non-quantum computer, input data of a polynomial function formatted for a quantum computer; solving, by the quantum computer, a vector of weight updates; and updating the weight in the model.

A system for accelerating a machine learning training process, comprising: a non-quantum computer that divides a set of data for training a machine learning model into a plurality of data batches, calculates a Jacobian matrix for each of the plurality of data batches, the Jacobian matrix and a vector being part of a linear matrix equation for updating a weight in the model, and arranges input data as a polynomial function formatted for a quantum computer; a quantum computer that solves the vector; and a computer module of the non-quantum computer for updating the weight in the model from the vector solved by the quantum computer.

In another aspect, a method to accelerate machine learning training, the method comprises sequential steps of: segmenting training data into a plurality of data batches based on data size and computational capability of a quantum computer; ranking the plurality of data batches based on a residual loss; selecting a current data batch from the plurality of data batches; calculating a Jacobian matrix for the current data batch; preparing the data for a quantum computer; sending the prepared data to a quantum computer; receiving, from the quantum computer, values at which the quadratic form reaches its minimum as a function of binary variables; solving for a loss vector to be found for a matrix equation of the Jacobian matrix by calculating its components via with the binary variables received from the quantum computer; updating a vector of weight updates in the model with the solved vector to produce an updated vector of weights; and comparing a change of loss with predetermined thresholds, wherein the change of loss is found by comparing the vector of weights with the updated vector of weights.

In another aspect, a method to accelerate machine learning training, the method comprising sequential steps of: segmenting training data into a plurality of data batches based on data size and computational capability of a quantum computer; ranking the plurality of data batches based on residual loss; selecting a current data batch from the plurality of data batches; calculating a Jacobian matrix with matrix elements (Jᵢⱼ) for the current data batch according to:

$${J}_{ij} = \frac{\partial {y}_{i}}{\partial {w}_{j}} {\vert}_{w}$$

wherein yᵢ is a prediction of a model for input data xᵢ wherein yᵢ=f(w, xᵢ) where f is the model, wⱼ is a jth weight in the model, w is a vector of weights with components wⱼ; preparing the data for quantum computer by representing a vector S with components Sⱼ via the binary variables

$${S}_{j} = {\sum }_{k = - {n}_{0}}^{{n}_{1} - 1} {2}^{k} {b}_{j k} - c ,$$

where n₀ and n₁ are integers defining a precision of decimal and whole parts of Sⱼ, bⱼₖ are binary variables, and

$$c = \frac{1}{2} {\sum }_{k = - {n}_{0}}^{{n}_{1} - 1} {2}^{k} ;$$

and calculating coefficients αⱼ_{₁}_{, k}_{₁}_{;j}_{₂}_{, k}_{₂} and β_{j,k} in a quadratic form Q=(J·S+F(w))² at the bⱼₖ binary variables by expending over the bⱼₖ binary variables according to Q=Σⱼ_{₁}_{, j}_{₂}_{,k}_{₁}_{,k}_{₂}αⱼ_{₁}_{,k}_{₁}_{;j}_{₂}_{,k}_{₂} bⱼ_{₁}_{,k}_{₁}bⱼ_{₂}_{,k}_{₂}+Σ_{j,k}β_{j,k}b_{j,k}, where F(w)=y−y_{data} is a vector that determines a loss evaluated on the vector of weights w, and y_{data} is a vector of expected outcomes, thereby producing prepared data αⱼ_{₁}_{,k}_{₁}_{;j}_{₂}_{,k}_{₂} and β_{j,k}; sending the prepared data αⱼ_{₁}_{,k}_{₁}_{;j}_{₂}_{,k}_{₂} and β_{j,k} to a quantum computer; receiving, from the quantum computer, values \hat{b}_{j,k} at which the quadratic form Q reaches its minimum as a function of the bⱼₖ binary variables; solving for S by calculating its components via

$${S}_{j} = {\sum }_{k = - {n}_{0}}^{{n}_{1} - 1} {2}^{k} {\hat{b}}_{j k} - c$$

with the binary variables received from the quantum computer; updating the vector of weights in the model as w_{updated}→w+S, thereby producing an updated vector of weights w_{updated}; and comparing a change of loss with predetermined thresholds, wherein the change of loss is found by comparing the vector of weights w with the updated vector of weights w_{updated}, wherein the steps of calculating, preparing, sending, solving and updating are repeated until the predetermined thresholds withing the data batches and for the whole data set are satisfied.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention. In the drawings:

FIG. 1 is a block diagram of a system for accelerating a machine learning training operation, in which embodiments of the present inventive concept can be practiced.

FIG. 2 is a flow diagram of a method for machine learning training, in accordance with some embodiments.

FIG. 3 is a block diagram of the non-quantum computer of FIG. 1, in accordance with some embodiments.

FIG. 4 is a block diagram of a system for accelerating machine learning model training, in accordance with some embodiments.

FIGS. 5A and 5B are graphs showing results of the method of FIG. 2.

FIG. 6 is a graph illustrating a comparison of a number of steps required to train a two-layer model using a conventional back-propagation method and a method in accordance with embodiments of the present inventive concept.

FIG. 7 is a graph illustrating a learning trajectory for a system with two batches, in accordance with embodiments of the present inventive concept.

FIG. 8A is a graph of results of a validation of a binary classification model trained to recognize the digit 7 in the National Institute of Standards and Technology (MNIST) database, in accordance with embodiments of the present inventive concept.

FIG. 8B is a graph of recall and false positive rates (FPR) results for the digit 7 in a MNIST dataset, in accordance with embodiments of the present inventive concept.

FIG. 9 is a graph of score results of the binary classification of the MNIST dataset of FIGS. 8A and 8B.

FIG. 10A is a graph of a receiver operating characteristic (ROC) curve for a binary classification model trained in the MNIST dataset of FIGS. 8A-9.

FIG. 10B is a graph of a precision-recall (PR) curve for a binary classification model trained in the MNIST dataset of FIGS. 8A-10A.

FIG. 11 is a flow diagram of a method for accelerating a machine learning training operation, in accordance with some embodiments.

### DETAILED DESCRIPTION

Conventional AI/ML realizations have two primary limitations in that they involve a (1) long, slow, and complicated AI/ML training procedure and (2) have a limited bandwidth for real-time information processing to re-calibrate and refine the AI/ML models. The embodiments of the present inventive concept herein address these two limitations by using quantum computers as hardware accelerators for AI/ML cloud computing, or more specifically, platforms where machine learning models can be developed. With this paradigm shift in AI/ML, the training time on large datasets can be reduced significantly, up to 100-fold, and the speed of an operation can be increased 10-fold or more.

In brief overview, embodiments of the present inventive concept include computing devices, systems, and methods method that utilize quantum computing as a tool to accelerate an AI/ML system to build, deploy, and operate in an efficient manner. The AI/ML building platform offers a quantum leap in AI/ML by enabling one to train the models “on the fly” on fast-evolving and fast-growing datasets and thereby significantly improving their prediction and classification functions. For training operations, quadratic or other polynomial form minimization occurs on a quantum computer to optimize the neural network, and in doing so, the network output's derivatives are combined as a Jacobian matrix.

The AI/ML building platform can be for a broad array for applications ranging from fundamental science to research and design, to logistics, the internet of things, and national security. As is well-known, there are two primary types of quantum computers: annealing quantum computers and general-purpose quantum computers. While computers of the first type are mostly adjusted for solving mathematical optimization problems, the general-purpose quantum computers perform a broader range of operations and can perform more complex computational tasks. Embodiments of the disclosed method include quantum computers that accelerate certain mathematical operations that routinely appears in the AI/ML model training and running. The advantage of the disclosed methodology in accordance with embodiments of the present inventive concept is that AI/ML algorithms are designed such a way that either type of quantum computer (quantum annealers and general-purpose quantum computers) is suitable to perform the accelerated tasks. In some embodiments where the methodology provides energy minimization via quantum computing operations, the quantum annealer can perform relevant operations by design, while the general-purpose quantum computers can use an underlying algorithm such as quantum approximate optimization algorithm (QAOA) to perform other relevant operations in a manner that minimizes the energy.

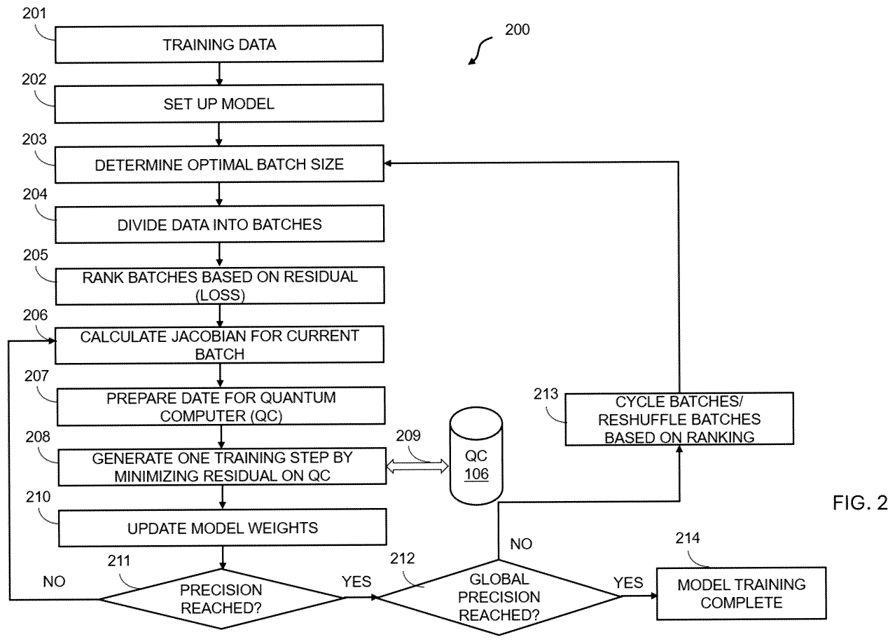

Since the standard methodology (e.g., back propagation or forward propagation) is not suitable for quantum computers, the disclosed method, for example, shown and described in FIG. 2, reformulates the AI/ML training procedure via the mathematical operations that can be efficiently performed on currently available quantum computers. For example, quantum computers can only perform certain types of operations (referred to as “gates” for the general-purpose quantum computers or energy minimization for quantum annealers). These operations are different from operations on regular computers (e.g., basic calculations such as addition, subtraction, multiplication and division). So, in most cases it is impossible just to execute a conventional computer algorithm on a quantum computer. Other examples of an AI/ML training procedure reformulated via mathematical operations that can be efficiently performed on currently available quantum computers include computer vision tasks such as image recognition, pattern recognition and supervised machine learning.

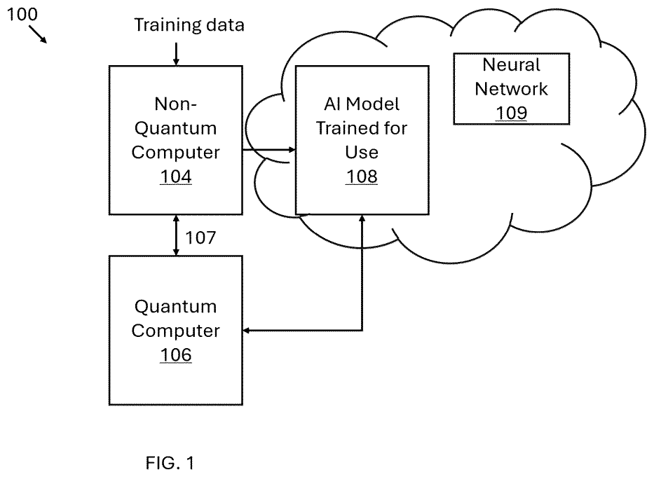

FIG. 1 is a block diagram of a system 100 for accelerating a machine learning training operation, in which embodiments of the present inventive concept can be practiced. The system 100 includes a conventional computer 104, also referred to as a non-quantum computer or a first computer, and a quantum computer 106, also referred to as a second computer. One application of the system 100 may be a cloud computing environment where AI is implemented to process, e.g., identify and catalog, data generated and stored in the cloud. For example, AI may be implemented, and accelerated by the combination of quantum and non-quantum computers, to monitor the vast number of transactions performed by a large bank. Other applications may equally apply.

The non-quantum computer 104 can be a digital computer, for example, having a processor, memory, and so on for storing and executing software for preparing binary data. The non-quantum computer 104 is configured to receive and process the training data to prepare data for the quantum computer 106 to solve for certain mathematical operations that routinely appears in AI model training, for example, matrix equation vectors, that could not otherwise be processed by the quantum computer 106 due to the standard methodology of the original data, by reformulating the AI training procedure via the mathematical operations that can be efficiently performed on the quantum computer 106. The data output of the non-quantum computer 104 may be transmitted to the quantum computer 106 by a known means of communicative connection, for example, well-known private or public networks. The output for training the AI model 108, or output of the algorithm of interest applied to the dataset, is also transmitted by a known means of communicative connection. The AI model training 108 is therefore achieved by feeding the training data to selected algorithms that are assisted by the quantum computer 106 so that an AI/ML cloud computing system or the like can refine itself to produce accurate responses to queries. logical neural network 109 can be implemented to exchange data with the computers 104 and/or 106, for example, to provide the classification of an image as the output. For example, one application of the system is image recognition, where pictures are classified based on the neural network 109 trained by the system.

FIG. 2 is a flow diagram of a method 200 for machine learning training, in accordance with some embodiments. Some or all of the method can be implemented in the system 100 of FIG. 1, but not limited thereto. More specifically, some or all of the steps 201-214 may be performed by the non-quantum computer 104 which communicates with the quantum computer 106, which performs operations on data received from the non-quantum computer 104, described below.

At step 201, training data 201 used to train machine learning and artificial intelligence models is provided by a user to train the algorithms that is, to adjust the weights, or learnable parameters, in the AI/ML model. The training data 201 may include labeled images, text documents, audio recordings, sensor information, internet data collection results, and so on.

When training the algorithms, the adjust the weights, or learnable parameters, in the AI/ML model are adjusted by the training data. As is well-known, the weights in a neural network (e.g., 109 in FIG. 1) may be values associated with the connections between neurons or nodes across different layers of the network, and more specifically, can be used to control the strength of a signal between neurons. The method can be used to train neural networks of neurons (shallow and/or deep networks). Here, the parameters are adjusted during the training process to minimize the difference between the actual output and the target output. The size of the data varies in wide limits and ranges from a several items for small data sets to petabytes of data for large data sets (e.g., in the high-definition video analyses, massive user data analytics, etc.)

At step 202, the AI model is set up. In some embodiments, the model is set up in terms of the number of neural network layers (e.g., neural network 109 in FIG. 1), the number of perceptrons in each layer of a logical machine language network or multilayer perceptron neural network, and activations functions in each layer. This setup can include fully connected layers, convolution layers, pooling layers, and layer other types. The setup of the model includes a setting of the number of layers, types of layers, number of perceptrons in each layer, connection between the perceptrons, choice of the activation functions, or a combination thereof.

At step 203, the optimal batch size is determined based on the quantum computer memory requirements. In particular, the non-quantum computer 104 determines the data size and represents the data as an array of data chunks (batches) that can fit the memory and computational capability of quantum computers.

Since the capability varies a lot in modern computers from a few logical elements (quantum bits or qubits) to thousands of qubits, in step 204, the non-quantum computer 104 is required to break the data into batches, each of which fits the capability of the specific computer that performs operations. The weights in the model are initialized as random numbers having real number weights instead of Boolean weights. For each batch, the residual (the loss function), R, is calculated with the standard procedure. For example, the L−n norm,

$$R = {L}^{n} ( {y}_{i} , {y}_{data , i} ) = \frac{1}{{m}_{b}} {\sum }_{i = 1}^{{m}_{b}} {\vert {y}_{i} - {y}_{data , i} \vert}^{n}$$

can be used as the loss function estimator. (Here, y₁=f(w, xᵢ) is the prediction of the model for the input data xᵢ, f is the model and y_{data,i} is the expected outcome of the model, and w are the weights in the model. The index i=1 . . . m_{b} marks the input data in the batch, m_{b} is the batch size, and n=1, 2, 3, . . . is the rank of the norm.) Other loss function estimators can be used including smooth mean absolute value (Huber loss function), log-cosh loss function and so on. Then, at step 205, the batches are ranked in the order of decreasing losses and the ranked batch list is created. This operation enables the system to train the model first on the data batches, for which the initial parameters are most “off” and then fine tune over the data, for which only minimal adjustments of the parameters are needed.

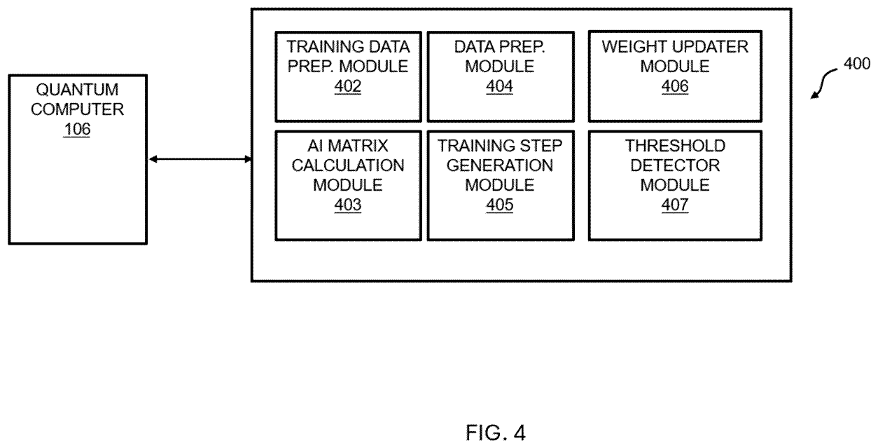

At step 206, the AI matrix calculation module 403 shown in FIG. 4 takes one batch of data starting from the batch with the largest loss in the ranked list formed in steps 202-205. For each batch in the ranked list, the AI matrix calculation module 403 calculates for the matrix elements Jᵢⱼ of the Jacobian matrix J of the AI model according to the equation (1),

$${{J}_{i j} = \frac{\partial {y}_{i}}{\partial {w}_{j}} \vert}_{w} \qquad ( 1 )$$

Here, y₁ is defined above, wⱼ is the jth weight in the model, including the biases; w is the vector of weights with the components wⱼ. The matrix elements Jᵢⱼ of the Jacobian matrix J are evaluated for each data xᵢ in the batch using the current weights wⱼ of the model. These calculations are done on a regular (non-quantum) computer 104.

At step 207, the data preparation module 404 of FIG. 4 prepares the data for a quantum computer to solve a linear matrix equation to update the weights in the model:

J·S=−F(w), (2)

where J is the Jacobian matrix with the matrix elements Jᵢⱼ calculated in equation (1) in step 206. S is a vector to be found, F(w)=y−y_{data} is a vector that determines the loss in the model evaluated on the current vector of weights w for the data for the chosen data batch, and y_{data} is vector of the expected outcomes of the model. Accordingly, the Jacobian matrix and the loss vector are part of a linear matrix equation for updating a weight in the model. The vector y=(y₁, y₂, . . . , yₘ) has components y₁ (i=1, . . . , m_{b}) which are the prediction of the model for the input data xᵢ in the batch, and the vector y_{data} (y_{data,1}, y_{data,2}, . . . y_{data,m}_{_{b}}) has components y_{data},i (i=1, . . . , m_{b}) which are the expected outcome of the model for data xᵢ in the batch. The vector F defined above is different from the loss function R that module 102 uses to rank the batches. The data for a quantum computer in step 207 is prepared on a regular computer in a form of a quadratic form Q which is a polynomial function of S and is proportional to the L−2 norm mean square error loss with the coefficient of proportionality m_{b},

Q=(J·S+F(w))² (3)

In a binary polynomial model framework available on either type of quantum computer, e.g., quantum annealer or general-purpose quantum computer, each component Sᵢ of the vector S is binarized by representing it as a series over the binary variables bⱼₖ,

$${S}_{j} = {\sum }_{k = - {n}_{0}}^{{n}_{1} - 1} {2}^{k} {b}_{j k} - c , \qquad ( 4 )$$

where the integer numbers n₀ and n₁ define the precision of the decimal and whole parts of the number Sⱼ, and c is a positive number introduced to account for negative values of Sⱼ. The value of c can be chosen based on the nature of data xᵢ; in our calculations we use

$$c = \frac{1}{2} {\sum }_{k = - {n}_{0}}^{{n}_{1} - 1} {2}^{k} .$$

However, this binarization step can be omitted if the quantum computer 106 supports operations with floating point variables.

In step 208, the quantum computer 106 solves equation (2) for the vector S to be found for the matrix equation by finding the minimum of the quadratic form Q. The interface module 405 makes one training step by minimizing the residual (R) on the quantum computer 106. Minimization of the quadratic form Q is an optimization problem and is suitable for all existing type of quantum computers, for example, on a quantum annealing computer or via the quantum approximate optimization algorithm (QAOA) on a general-purpose or universal gate-based quantum computer.

To minimize the quadratic form Q over the binary variables bⱼₖ, the data for the quadratic form Q are loaded into a quantum computer 106. The data for the quadratic form Q are the numerical coefficients at the quadratic terms, bⱼ_{₁}ₖ_{₁}bⱼ_{₂}ₖ_{₂} and linear terms bⱼₖ obtained after substituting Sⱼ, eq. (4) (with j, j₁,j₂=1, . . . , m_{b} and k, k₁, k₂=−n₀, . . . , n₁−1), to eq. (3) and expanding the resultant equation of powers of bⱼₖ. The data for the quadratic form Q can be transmitted locally to the quantum computer 106 if the regular and quantum computers are in the same facility, or it can be sent and received over the network if the quantum computer is in a remote facility. The transmission and reception of the data are shown in the data exchange 209 after the data is sent to the quantum computer 106 and the quantum computer 106 provides a result that includes minimizing the residual (R). The quantum computer 106 returns the solution, for the binary variables bⱼₖ. The vector S is calculated from the received solution for the vector S, or more specifically, for the binary variables bⱼₖ according to equation (4). Then, at step 210 performed by a regular computer 104 updates the vector of weights w of the model according to the equation

w_{updated}→w+S (4)

At decision diamond 211, the code compares the value of the polynomial format Q for the updated weights (w_{updated}) with the polynomial format for the weights (w) on the previous step for the batch. At operation 211, if the target precision condition is met, the method 200 continues to step 212 (“Yes” in 211). If the target precision condition is not met (“No” in 211), the code repeats the operations in steps 203-210 until the precision condition for the batch is met.

Then the code compares the global precision condition for all data with the target precision in step 212. If the precision condition is not met (“No” in 212), the code proceed to step 214 where another data batch is chosen based on the ranking made in step 202-205, and the operations in modules 202-212 is repeated. To avoid cycling in the optimization where the optimum is not achieved, the ranking is updated and the batches are reshuffled based on the updated ranking. If the precision condition is met (“Yes” in 212), the model is trained in ready for the use by the user.

The method 200 reformulates an AI/ML training procedure that uses mathematical operations that can be efficiently performed on currently available quantum computers, while other elements of the training procedure may be performed by conventional computers. Here, the method is reformulated in such a way that a system of equations is solved on a quantum computer. The solution of the system gives updates of the weights in the model.

In other embodiments, another method may be applied that is similar to method 200 to accelerate machine learning training may be performed. Here, the method comprises sequential steps of: segmenting training data into a plurality of data batches based on data size and computational capability of a quantum computer; ranking the plurality of data batches based on residual loss; selecting a current data batch from the plurality of data batches; calculating a Jacobian matrix with matrix elements (Jᵢⱼ) for the current data batch according to:

$${{J}_{i j} = \frac{\partial {y}_{i}}{\partial {w}_{j}} \vert}_{w}$$

wherein yᵢ is a prediction of a model for input data xᵢ wherein yᵢ=f(w, xᵢ) where f is the model, wⱼ is a jth weight in the model, w is a vector of weights with components wⱼ; preparing the data for quantum computer by representing a vector S with components Sⱼ via the binary variables

$${S}_{j} = {\sum }_{k = - {n}_{0}}^{{n}_{1} - 1} {2}^{k} {b}_{j k} - c ,$$

where n₀ and n₁ are integers defining a precision of decimal and whole parts of Sⱼ, bⱼₖ are binary variables, and

$$c = \frac{1}{2} {\sum }_{k = - {n}_{0}}^{{n}_{1} - 1} {2}^{k} ;$$

and calculating coefficients αⱼ_{₁}_{,k}_{₁}_{;j}_{₂}_{,k}_{₂} and β_{j,k} in a quadratic form Q=(J·S+F(w))² at the bⱼₖ binary variables by expending over the bⱼₖ binary variables according to Q=Σⱼ_{₁}_{,j}_{₂}_{,k}_{₁}_{,k}_{₂}αⱼ_{₁}_{,k}_{₁}_{;j}_{₂}_{,k}_{₂} bⱼ_{₁}_{,k}_{₁}bⱼ_{₂}_{,k}_{₂}+Σ_{j,k}β_{j,k}b_{j,k}, where F(w)=y−y_{data} is a vector that determines a loss evaluated on the vector of weights w, and y_{data} is a vector of expected outcomes, thereby producing prepared data αⱼ_{₁}_{,k}_{₁}_{;j}_{₂}_{,k}_{₂} and β_{j,k}; sending the prepared data αⱼ_{₁}_{,k}_{₁}_{;j}_{₂}_{,k}_{₂} and β_{j,k} to a quantum computer; receiving, from the quantum computer, values b_{j,k} at which the quadratic form Q reaches its minimum as a function of the bⱼₖ binary variables; solving for S by calculating its components via

$${S}_{j} = {\sum }_{k = - {n}_{0}}^{{n}_{1} - 1} {2}^{k} {\hat{b}}_{j k} - c$$

with the binary variables received from the quantum computer; updating the vector of weights in the model as w_{updated}→w+S, thereby producing an updated vector of weights w_{updated}; and comparing a change of loss with predetermined thresholds, wherein the change of loss is found by comparing the vector of weights w with the updated vector of weights w_{updated}, wherein the steps of calculating, preparing, sending, solving and updating are repeated until the predetermined thresholds withing the data batches and for the whole data set are satisfied.

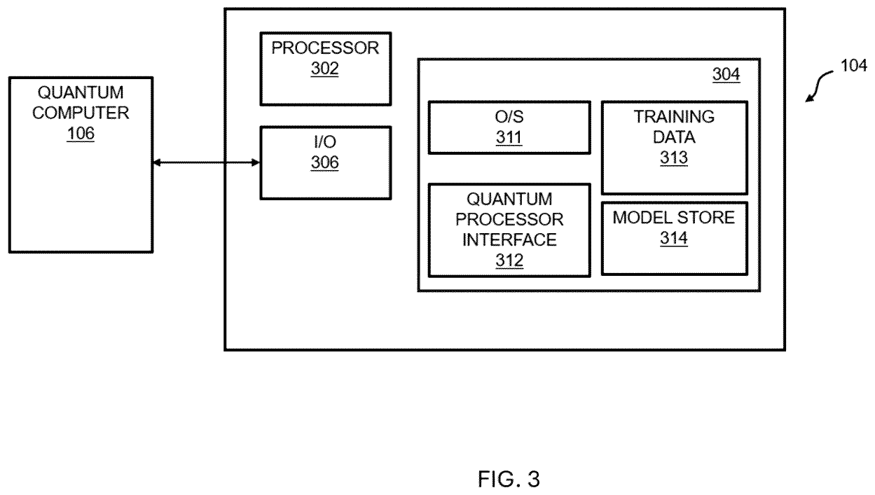

FIG. 3 is a block diagram of the non-quantum computer 104 of FIG. 1, in accordance with some embodiments. The non-quantum computer 104, also referred to as a regular computer, includes at least one processor 302 that performs some or al computer processing tasks described in the method 200 of FIG. 2. The quantum computer 104 is constructed for performing some tasks of the method 200 while preparing data for relevant mathematical operations for a quantum computer 106. The non-quantum computer 104 may have a configuration known to those skilled in the art such as computer servers, mobile devices, personal computers (“PCs”), and the like. The non-quantum computer 104 may be part of a distributed computing environment, where tasks or modules are performed by remote processing devices, which are linked through a communications network. In a distributed computing environment, the program modules may be located in both local and remote memory storage devices.

In addition to the at least one processor 302, the non-quantum computer 104 may include at least one system memory 304 and an I/O interface 306, which is configured to communicate with the quantum computer 106.

The processor 302 may be constructed and arranged as a central processing units (“CPU”), digital signal processors (“DSP”), application-specific integrated circuits (“ASIC”), and so on. The processor 302 may electronically communicate with the memory 304 and I/O interface 306 via a bus or the like, for example, memory bus, peripheral bus, network bus, and the like.

The memory 304 may include read-only memory (“ROM”), random access memory (“RAM”), non-volatile memory, or other memory known to those of ordinary skill in the art. The memory 304 may store an operating system 311, quantum processor interface 312, AI/ML training store 313, and various modules 314 used by the processor 302 to execute operations and functions of the method 200 of FIG. 2. The interface 312 can establish communications with the quantum computer 106 by a known means of communicative connection, for example, a network or direct connection. The training store 313 may store historical data and training sets developed from the historical data. The other various modules 314 may include some or all of the modules of the system 400 described below with respect to FIG. 4.

FIG. 4 is a block diagram of a system 400 for accelerating machine learning model training, in accordance with some embodiments.

The system 400 comprises a training data processing module 402, AI matrix calculation module 403, data preparation module 404, a training step generation module 405, a weight updater module 406, and a threshold detector 407. Some or all of the modules 402-407 may be referred to as the other various modules 314 in FIG. 3, and in doing so may be stored in the memory 304 and executed by, the processor 302 of FIG. 2. The training step generation module 405, in particular, may also rely on the quantum processor interface 312 of FIG. 3 to exchange data with the quantum processor 106. The various modules 202-207 of the system 400 may perform some or all of the method 200 of FIG. 2.

In particular, the training data processing module 402 receives a source of training data and in response, sets up the model, determines an optical batch size based on quantum computer memory requirements, divides the data into batches, and ranks the batches based on the residual, for example, ranked in the order of decreasing losses. The system recognizes the memory requirements either by the users who should the total number of qubits in the quantum computer of the system, or by computer-generated requests of this parameter automatically from the quantum computer. The AI matrix calculation module 403 can select a current batch with the largest loss, and calculate a Jacobian matrix or the like with matrix elements for the current data batch. This matrix can be used to determine how local perturbations the neural network input may impact the output. The data preparation module 404 can prepare the data for the quantum computer 106 to solve a linear matrix equation to update the weights in the model. The training step generation module 405 can process the data for a single training step by minimizing the residual on the quantum computer 106, and load the data for a polynomial function, for example, quadratic form, into the quantum computer 106. In particular, the estimated mean square error loss for the current state of the model is calculated so that the weights can be updated to reduce the loss for the next iteration of the training process. The training step generation module 405 can also receive a returned solution from the quantum computer 106, which may include a solution to binary variables used by the weight updater module 406 to update the model weights. The threshold detector 407 can compare the value for the quadratic form for the updated weights with the weights on a previous step for the batch. If the condition is not met, then the threshold detector 407 communicates with the AI matrix calculation module 403 to perform a new set of calculations until the condition is met. The threshold detector 407 can also compare the global precision condition for all data with the target precision condition in step 212 in FIG. 2. If the precision condition is not met, then the threshold detector 407 selects another batch based on the ranking determined by the training data processing module 402. If the precision condition is et, then the model training operation is complete and the model is ready for use.

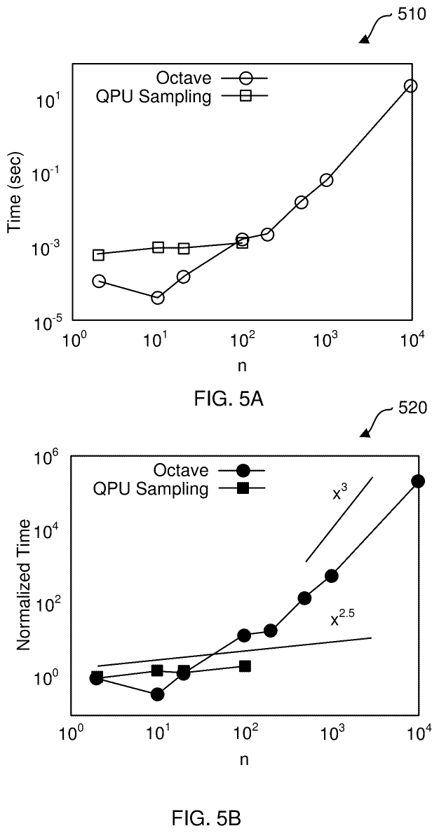

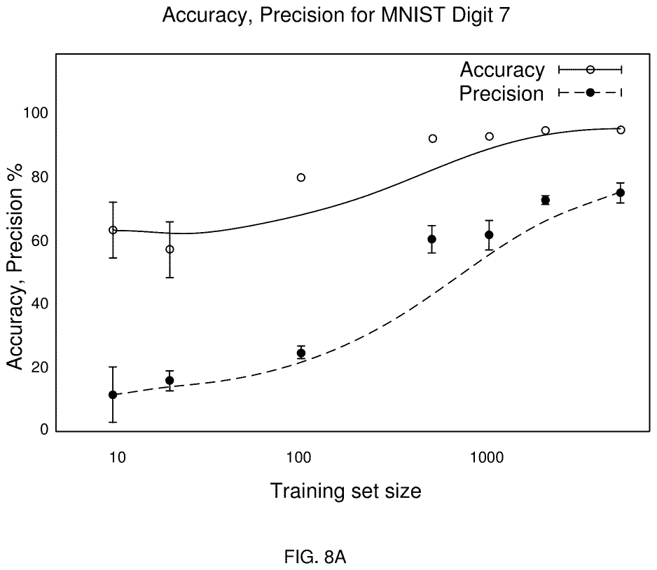

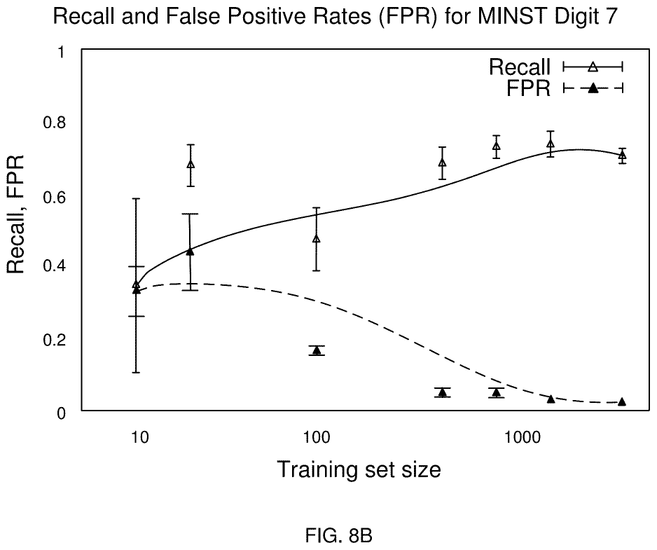

FIGS. 5A and 5B are graphs showing results of the method of FIG. 2. The horizontal axis shows the number of qubits used in the model, n, and the vertical axes shows the execution time for one batch in seconds. The square symbols and curve quantum processing unit (QPU) sampling correspond to the calculation on a quantum computer, e.g., 106, using a line binary quadratic model (BQM). Other time-related algorithms can be run in polynomial time. Problems submitted directly to the quantum computer in a BQM format may be solved by a quantum computer constructed to accept constrained or unconstrained arbitrarily structured quadratic models. The round symbols and curve shown in FIGS. 8A and B correspond to similar calculations made on a laptop computer with an AI architecture including a high-level programming language primarily designed for numerical computations and data analysis, such as an Octave system. It shown in the graph 510 in FIG. 5A, the execution time on a quantum computer becomes comparable with that for the AI architecture with the number of qubits n~100. The time normalized to the execution time at n=2 (the leftmost point in FIG. 5A) is shown on the graph 520 in FIG. 5B. The normalized execution time for a quantum computer is approximated by the function ~n^{0.25} whereas for AI calculations, the execution time is approximated by the function ~n³. At n>20, the normalized time for the quantum computer is shorted than that for AI that indicates the quantum advantage of the method 200 described with respect to FIG. 2.

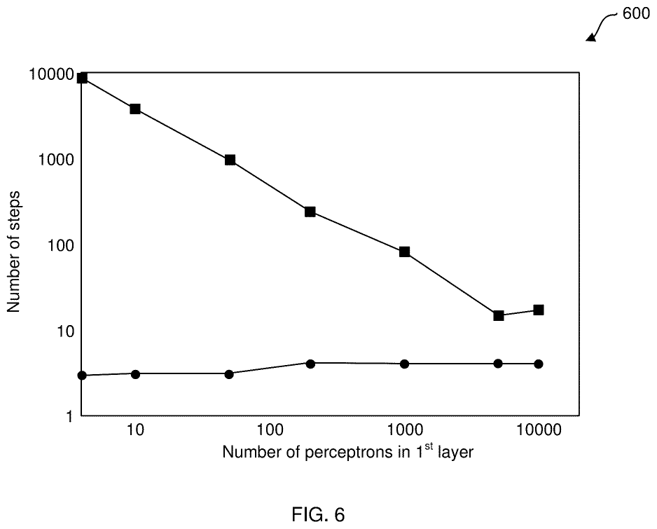

FIG. 6 is a graph 600 showing the comparison of the number of steps needed to train a two-layer model using the back-propagation method on pytorch (square symbols) and with the disclosed method (circular symbols). The horizontal axis shows the number of perceptrons in the first (hidden) layer. The number of perceptrons in the second (output) layer was fixed and set equal to one. It is seen that it needs ~10,000 numerical steps to train the model with the back-propagation method for a few perceptrons in the hidden layer. The number of steps is reduced to ~12 for the model with 10,000 perceptrons. The number of steps for the proposed method varies between 3 and 6 and only weekly depends on the size of the hidden layer. For all sizes in this calculation, the number of steps top train the model is smaller for the method 200.

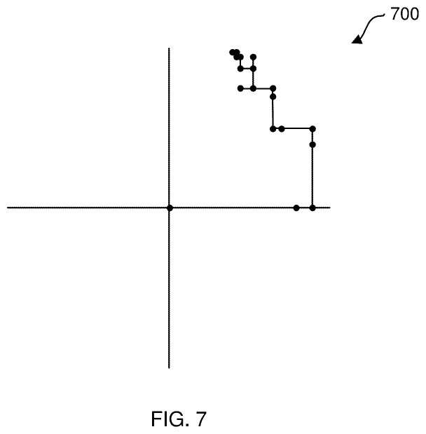

As shown in the graph 700 in FIG. 7, demonstrated is the model training using method 200 of FIG. 2 with several batches. The result for optimization with only 2 weights is shown in FIG. 7. The horizontal axis shows the steps for weight #1 (batch one) and the vertical axis shows the step for weight #2 (batch 2). The filled points show the positing of the point (w₁, w₂) on the plane, the segments connect the points in subsequent optimization steps. It is seen in FIG. 7 that the system converges to an optimum after a finite number of steps (19 steps in FIG. 7) that justifies the method 200.

To further demonstrate the validity of the disclosed method, the standard characteristics of the trained model has been determined. In this calculation, we used the open-source MNIST database of the handwritten digits commonly used for training image processing systems.

To reduce the amount of needed resources, the original MNIST picture quality (28×28 grayscale pixels) was downgraded to 14×14 grayscale pixels. In this demonstration, the binary classification model was used where the model recognizes a specific digit from the set. For example, the model was asked to determine if an image contains digit 7. In this calculation, we calculated the accuracy and precision of the trained model as a function of the size of the training set on which the model was trained. (In what follows we refer to that size as the training set size.) The training set size was varied from N=10 to 5,000 images. The validation set size was set to 5,000. The accuracy was determined as the percentage of correct classifications that a trained model achieves, i.e., the number of correct predictions divided by the total number of predictions. The precision was calculated as the number of true positives divided by the total number of positive predictions. To demonstrate the capability of the disclosed method, in the training we use one batch, m_{b}=N, where N is the total number of data elements xᵢ. The precision of the decimal part in eq. (4) was set to n₀=5 while the precision of the whole part was n₁=1.

The results of the validation of the binary classification model trained to recognize the digit 7 in the MNIST dataset are shown in FIG. 8A. Here, the points show the average over three independent runs, the vertical bars show the standard deviation from the average. The solid curves show the approximation of the obtained dependencies via Bezier splines. Training was performed only for one epoch where branching was forcefully set to “Yes.” It is seen in FIG. 8A that after just one epoch the accuracy of the binary classification reaches 94.4±0.5% (where 0.5 is the classification threshold) while the precision reaches 74.8±3.1% for the training set size of 5,000 images. The difference between the accuracy and precision appears due to imbalance of the training set, in which a specific digit (e.g., 7) appears on average in 10% of the data.

Dependence of the recall and false positive rate (FPR) on the training set size for the binary classification model to recognize the digit 7 in the MNIST data set is shown in FIG. 8B. The recall, also known as the true positive rate (TPR), is calculated as the proportion of images that the model correctly identifies as having the specific digit out of the total number of this digit in the data set. The false positive rate (FPR) is the proportion of all images that the model erroneously identifies as having the specific digit out of the total number of images that the model identifies as having that digit. It is seen in FIG. 8B that the recall reaches 0.7078±0.0208 whereas the FPR is as low as 0.0282±0.0039 for the training data set size of 5,000 images.

To better characterize the disclosed method, the system calculates the dependence of F₁ score as a function of the threshold for the binary classification on MNIST data set. In some embodiments, the F₁ score is calculated as

$${F}_{1} = \frac{2}{\frac{1}{Precision} + \frac{1}{Recall}}$$

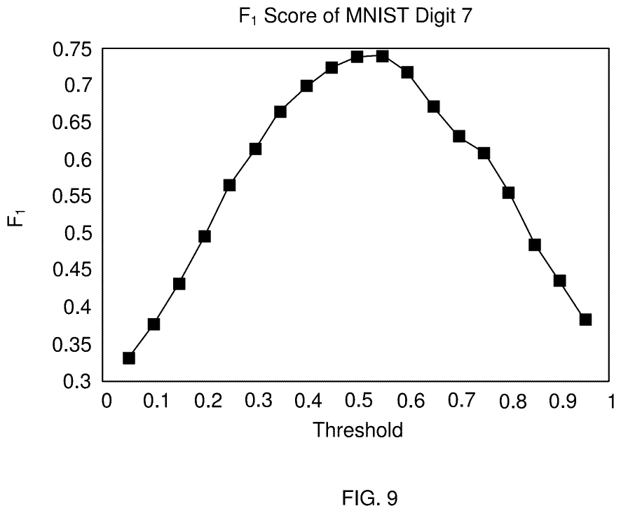

The precision and recall were taken from data similar to those shown in FIGS. 8A and 8B. The results are shown in FIG. 9. The training set size was taken 5,000 images. It is seen that the maximum of the F₁ score reaches 0.739 for the classification thresholds of 0.5 and 0.6.

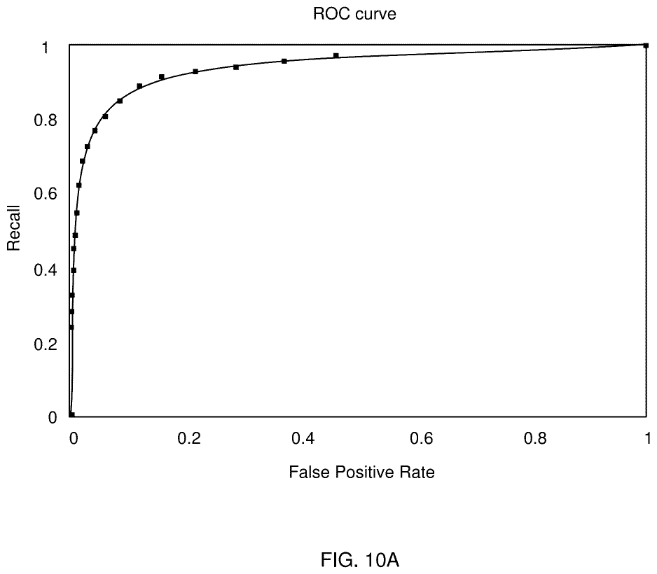

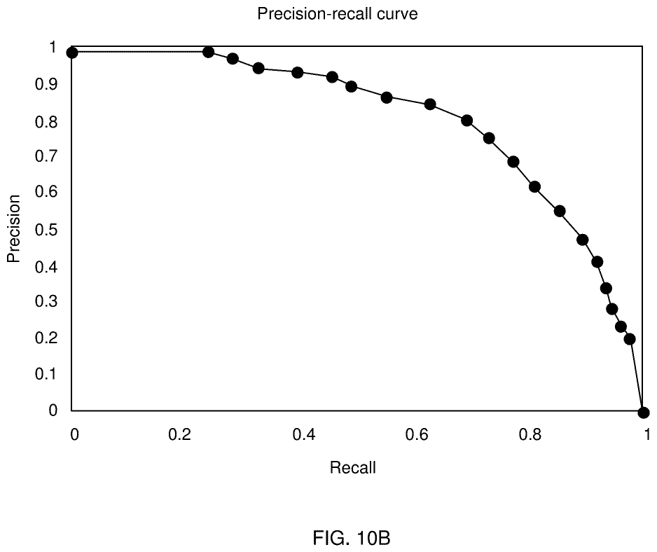

Also plotted are the receiver operating characteristic (ROC) and precision-recall (PR) curves for the binary classification model trained on the MNIST data set. An example for the model trained to recognize digit 7 is shown in FIGS. 10A and 10B. The area under the ROC curve (AUC) in FIG. 10A is AUC=0.941±0.008. The area under the precision-recall (PR) curve in FIG. 10B is AUC-PR=0.795±0.017. The uncertainties in the areas were determined via averaging over three independent training instances. It is seen that the F₁ score, area under the ROC curve (AUC) and area under the precision-recall curve (AUC-PR) are consistently greater than 0.70. Therefore, the disclosed method demonstrates satisfactory predictive performance after training on only one epoch. In contrast, the standard AI/ML methods (for example, for fully connected deep learning models and convolution models) require training on multiple epochs (often 10+ epochs) to show similar performance.

A broad range of applications are foreseen. The applications beyond the ML building/training platform include high-precision general positioning system (GPS), for example, provided by Esri, Naurt, or the like, processing of satellite data and image recognition, for example, provided by NASA, L3 Harris Geospatial, Maxar Tech, or the like as well as quantitative finances and drag development, for example, provided by Multiverse, Menten AI, or the like, and training of large language models such as ChatGPT, for example, provided by OpenAI or the like.

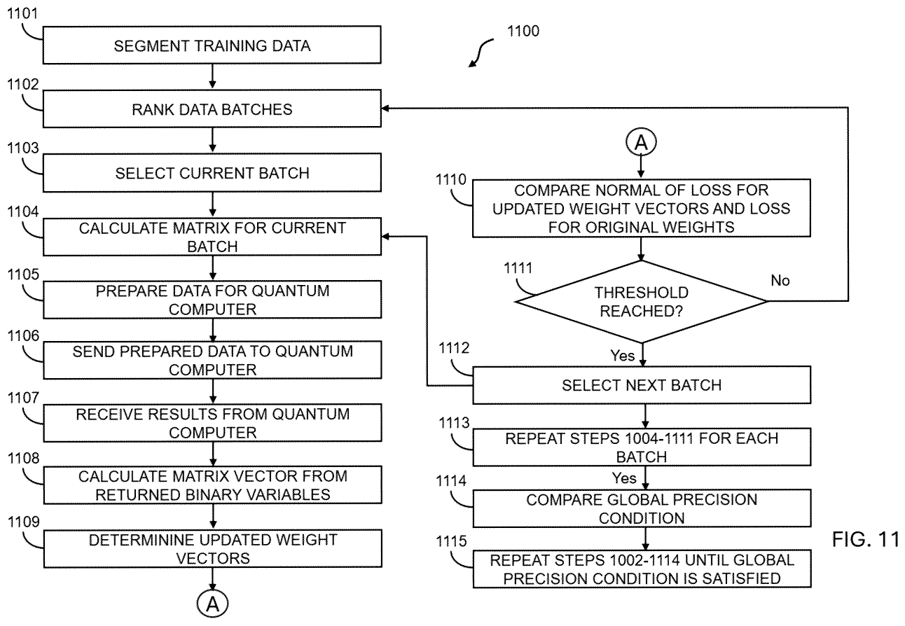

FIG. 11 is a flow diagram of a method 1100 for accelerating a machine learning training operation, in accordance with some embodiments. The method 1100 can be performed for an application mentioned above, for example, GPS, quantitative finances, and so on, but not limited thereto. Some or all of the method can be implemented in the system 100 of FIG. 1, but not limited thereto. Although described above with respect to the method 200 of FIG. 2, the various results shown in FIGS. 5A-10B may be produced by the method 1100.

In step 1101, training data is segmented, for example, by the training data processing module 402 of FIG. 4, into a plurality of data batches based on data size and computational capability of a quantum computer 106.

In step 1102, the plurality of data batches are ranked based on the loss, for example, by the training data processing module 402 of FIG. 4. The loss, R is determined by the L−n norm,

$$R = {L}^{n} ( {y}_{i} , {y}_{data , i} ) = \frac{1}{{m}_{b}} {\sum }_{i = 1}^{{m}_{b}} {\vert {y}_{i} - {y}_{data , i} \vert}^{n} ,$$

or any other loss function estimators such as smooth mean absolute value (Huber loss function), log-cosh loss function and so on.

In step 1103, a current batch is selected from the plurality of data batches by choosing the batch with the largest loss R.

In step 1104, in the AI model matrix calculator 403, a Jacobian matrix J with the matrix elements Jᵢⱼ is calculated for the current data batch according to:

$${{J}_{i j} = \frac{\partial {y}_{i}}{\partial {w}_{j}} \vert}_{w}$$

wherein yᵢ is a prediction of a model for input data xᵢ wherein yᵢ=f(w, xᵢ) where f is the model, wⱼ is a jth weight in the model, w is a vector of weights with the components wⱼ. To demonstrate the work flow of the disclosed method, here we give a specific example when the method determines the outcomes of the logical AND operation for two binary data variables, α₁ and α₂. This model may be referred to as “the logical AND model.” We assign α₁=1 if the jth data variable is logical “True” and α₁=0 if the jth data variable is logical “False” for both j=1,2. The bias α₃=1 in the model is introduced as the third variable in the data. Thus, the data is a vector with three components, xᵢ=(α_{i,1}, α_{i,2}, α_{i,3}) where the index i marks all possible combinations of the binary data variables. In this logical AND model, the binary classification is with only 2 binary variables thus, there are 2²=4 possible combinations of the data and, therefore, the index varies i=1 . . . 4. For example, if the first variable is “False” and second is “False”, the respective data is x₁=(0, 0, 1); if the first variable is “False” and second is “True”, the respective data is x₂=(0, 1, 1) and so on. For the sake of simplicity of this basic example, we set the activation function in the model to be a linear function; in this case, the model is f(w, x)=w·x≡w₁α₁+w₂α₂+w₃α₃ (where the dot symbol denotes the scalar product of two vectors). The prediction of the model is yᵢ=f(w, xᵢ) and the expected outcome of the model is y_{data,i}=, α_{i,1}Λα_{i,2} ≡α_{1,i}α_{i,2}. In this model, the Jacobian matrix has the matrix elements

$${{J}_{i j} = \frac{\partial {y}_{i}}{\partial {w}_{j}} \vert}_{w} = {a}_{i j}$$

which do not depend on the weights w₁, w₂ and w₃. However, in more complex examples, (e.g., if f(w, x)=(w·x)²), the matrix elements Jᵢⱼ would depend on the weights w₁, w₂ and w₃ and the values of the weights at which they are initialized should be plugged in into the formulas for Jᵢⱼ.

In step 1105, the vector S is represented via the binary variables b_{j,k} according to eq. (4). In the example considered in the previous paragraph, we consider the binarization of the S vector with a single digit precision in the decimal part, n₀=1, and a single digit precision in the whole part, n₁=1. Therefore, we binarize the components of the vector S as follows,

$${S}_{j} = \frac{1}{2} {b}_{j , 1} + {b}_{j , 2} - c ,$$

where j=1,2,3; b_{j,k} are the binary variables that can only be either 0 or 1, and

$$c = \frac{3}{4} .$$

In step 1106, in the data preparation module 404 of FIG. 4, the coefficients in the quadratic form Q are calculated according to the following equations

Q=(J·S+F(w))²

wherein J is the Jacobian matrix with the matrix elements Jᵢⱼ. S is a vector to be found, F(w) is a vector that determines the loss in the model evaluated on the vector of weights w, with which the model was initialized. Continuing the logical AND model example introduced above, one has

$${J}_{ij} = {a}_{ij} , {S}_{j} = \frac{1}{2} {b}_{j , 1} + {b}_{j , 2} - \frac{3}{4} ;$$

the vector that determines the loss in the model (that is, how far in the vector space the prediction of the model y is from the expected outcome y_{data}), is the following:

$$F ( w ) = y - {y}_{data} = {\sum }_{j = 1}^{3} ( {w}_{j} {a}_{i , j} ) - {a}_{i , 1} {a}_{i , 2} ;$$

and therefore, the quadratic form equals

$$Q = {\sum }_{i = 1}^{4} {( {\sum }_{j = 1}^{3} {a}_{i j} ( \frac{1}{2} {b}_{j , 1} + {b}_{j , 2} - \frac{3}{4} ) + {\sum }_{j = 1}^{3} ( {w}_{j} {a}_{i , j} ) - {a}_{i , 1} {a}_{i , 2} )}^{2} .$$

the components of the data xᵢ as it was Introduced in paragraph [00030] above. Then, the quadratic form is expanded of power of b_{i,j} as follows Q=Σⱼ_{₁}_{,j}_{₂}_{,k}_{₁}_{,k}_{₂}αⱼ_{₁}_{,k}_{₁}_{J}_{₂}_{,k}_{₂}bⱼ_{₁}_{,k}_{₁}bⱼ_{₂}_{,k}_{₂}+Σ_{j,k} β_{j,k}b_{j,k}. In this formula for Q, the summations over index j, j₁ and j₂ runs over data that is, from 1 to 4; whereas the summation over index k, k₁, and k₂ runs over the weights that is from 1 to 3. For example, in the logical AND model, one has

$${α}_{1 , 1 ; 1 , 1} = \frac{1}{8} , {α}_{1 , 2 ; 1 , 2} = \frac{1}{2} ,$$

and so on. The full set of coefficients αⱼ_{₁}_{,k}_{₁}_{;j}_{₂}_{,k}_{₂} and β_{j,k} are to be sent to a quantum computer.

In step 1107, the interface module 405 sends the coefficient αⱼ_{₁}_{,k}_{₁}_{;j}_{₂}_{,k}_{₂} and β_{j,k} to a quantum computer. The quantum computer returns the results, or more specifically, the binary variables b_{i,j} at which the quadratic form Q with the coefficients αⱼ_{₁}_{,k}_{₁}_{;j}_{₂}_{,k}_{₂} and β_{j,k} has the minimum values. The numerical values of the returned results, i.e., binary variables, are denoted by a hat symbol, \hat{b}_{j,k}.

In step 1108, the vector S is calculated based on the returned binary variables according to eq. (4). For example, in the logical AND model, the components of the vector S is calculated as follows:

$${S}_{j} = \frac{1}{2} {\hat{b}}_{j , 1} + {\hat{b}}_{j , 2} - \frac{3}{4} .$$

In step 1109, an updated vector of weights (w_{updated}) is found:

w_{updated}→w+S

In step 1110, a comparison is made between (1) the normal of the loss R_{updated} for the updated vector of weights (w_{updated}) and (2) the loss R for the original weights w. If the change in the loss is less than the batch threshold ε_{batch}, which is set up during the initialization of the model by the model setup module 402, |R_{updated}−R|<ε_{batch} of the model. ε_{batch} is set to a reasonably small number (e.g., ε_{batch}=10⁻⁴) however this value depends on the nature of the problem. As is was stated in paragraph

above, the L−2 norm can be used as the loss estimator function, thus,

$${R}_{updated}^{batch} = \frac{1}{{m}_{b}} {\sum }_{i = 1}^{{m}_{b}} {\vert f ( {w}_{updated} , {x}_{i} ) - {y}_{data} ( {x}_{i} ) \vert}^{2} , {R}^{batch} = \frac{1}{{m}_{b}} {\sum }_{i = 1}^{{m}_{b}} \vert f ( w , {x}_{i} ) - {y}_{data} ( {x}_{i} ) {\vert}^{2} .$$

that here, the summation is made over the current batch of data, i=1, . . . , m_{b}.

In decision diamond 1111, steps 1104 to 1110 are repeated until a threshold on the batch

$$\vert {R}_{updated}^{batch} - {R}^{batch} \vert < {ϵ}_{batch}$$

is satisfied.

In step 1112, the next batch of data in the ranked list of batches is taken and steps 1014-1110 are repeated until a threshold on the batch

$$\vert {R}_{updated}^{batch} - {R}^{batch} \vert < {ϵ}_{batch}$$

is satisfied for the current batch.

In step 1113, step 1112 is repeated for all batches in the ranked list of batches.

In step 1114, a comparison is made between the global precision condition where the loss is calculated for the whole set of data xᵢ. Specifically, the global loss estimator is calculated for the vector of weights at which we initialized the model, w, that is before the steps 1101-1113 were made,

$$R = \frac{1}{N} {\sum }_{i = 1}^{N} {\vert f ( w , {x}_{i} ) - {y}_{data} ( {x}_{i} ) \vert}^{2} ;$$

and also the loss is calculated for fully updated vector of weights, w_{updated}, obtained after the steps 201-212 were made,

$${R}_{updated} = \frac{1}{N} {\sum }_{i = 1}^{N} {\vert f ( {w}_{updated} , {x}_{i} ) - {y}_{data} ( {x}_{i} ) \vert}^{2} .$$

We note that the summation in both R and R_{updated} are made over the whole data set xᵢ, N is the total number of elements in the data set. The global precision condition is checked, |R_{updated}−R|<ε. Here E is the global precision threshold set during the initialization of the model in the module 402, performed at steps 202-205. The reasonable value of the threshold is ε=10⁻³ however, its value depends on the nature of the problem. If the global precision threshold is not achieved, the batches are ranked in the order of decreasing global loss R_{updated}, and steps 201-213 may be repeated until the global precision condition |R_{updated}−R|<ε is satisfied.

While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims not be limited to the particular embodiments disclosed, but that the claims will include all embodiments falling within the scope and spirit of the appended claims.

What is claimed is:

1. A method to accelerate machine learning training, the method comprising:
receiving, by a non-quantum computer, a set of data for training a machine learning model;
dividing the set of data into a plurality of data batches, each data batch determined according to predetermined requirements of a quantum computer;
calculating, by the non-quantum computer, a Jacobian matrix for each of the plurality of data batches, the Jacobian matrix and a loss vector being part of a linear matrix equation for updating a weight in the model;
arranging, by the non-quantum computer, input data as a polynomial function formatted for a quantum computer;
solving, by the quantum computer, a vector of weight updates; and
updating the weight in the model.

2. The method of claim 1, further comprising:
comparing a norm of the residual for the updated weight in the model and a norm for a model weight in a step prior to updating the weight to determine whether a target condition is met.

3. The method of claim 2, further comprising:
comparing a global precision condition for all data and an output of the condition to determine whether the training of the machine learning model is complete.

4. The method of claim 3, wherein if the global precision condition is not reached, then the batches are reshuffled based on ranking.

5. The method of claim 1, further comprising ranking the batches in an order of decreasing global loss.

6. The method of claim 1, wherein the quantum computer is at least one of an annealing quantum computer and a general-purpose computer.

7. The method of claim 1, further comprising: preparing the input data for the quantum computer to solve a linear matrix equation to update weights in the model.

8. The method of claim 1, preparing the input data for the quantum computer to solve a matrix equation: J·S=−F(w) for the Jacobian matrix.

9. A method to accelerate machine learning training, the method comprising sequential steps of:
segmenting training data into a plurality of data batches based on data size and computational capability of a quantum computer;
ranking the plurality of data batches based on a residual loss;
selecting a current data batch from the plurality of data batches;
calculating a Jacobian matrix and a loss vector for the current data batch;
preparing the data for a quantum computer;
sending the prepared data to a quantum computer;
receiving, from the quantum computer, values at which the quadratic form reaches its minimum as a function of binary variables;
solving for a vector to be found for a matrix equation of the Jacobian matrix and the loss vector by calculating its components via with the binary variables received from the quantum computer;
updating a vector of weights in the model with the solved vector to produce an updated vector of weights; and
comparing a change of loss with predetermined thresholds, wherein the change of loss is found by comparing the vector of weights with the updated vector of weights.

10. The method of claim 9, wherein the Jacobian matrix is calculated with matrix elements (Jᵢⱼ) for the current data batch according to:
$${{J}_{i j} = \frac{\partial {y}_{i}}{\partial {w}_{j}} \vert}_{w}$$
wherein yᵢ is a prediction of a model for input data xᵢ wherein yᵢ=f(w, xᵢ) where f is the model, wⱼ is a jth weight in the model, w is a vector of weights with components wⱼ.

11. The method of claim 9, wherein the data is prepared for the quantum computer by representing a vector S with components Sⱼ via binary variables
$${S}_{j} = {\sum }_{k = - {n}_{0}}^{{n}_{1} - 1} {2}^{k} {b}_{jk} - c ,$$
where n₀ and n₁ are integers defining a precision of decimal and whole parts of Sⱼ, bⱼₖ are binary variables, and
$$c = \frac{1}{2} {\sum }_{k = - {n}_{0}}^{{n}_{1} - 1} {2}^{k} ;$$
and calculating coefficients αⱼ_{₁}_{,k}_{₁}_{;j}_{₂}_{,k}_{₂} and β_{j,k} in a polynomial form Q=(J·S+F(w))² at the bⱼₖ binary variables by expending over the bⱼₖ binary variables according to Q=Σⱼ_{₁}_{,j}_{₂}_{,k}_{₁}_{,k}_{₂}αⱼ_{₁}_{,k}_{₁}_{;j}_{₂}_{,k}_{₂}bⱼ_{₁}_{,k}_{₁}bⱼ_{₂}_{,k}_{₂}+Σ_{j,k} β_{j,k}b_{j,k}, where F(w)=y−y_{data} is a vector that determines a loss evaluated on the vector of weights w, and y_{data} is a vector of expected outcomes, thereby producing prepared data αⱼ_{₁}_{,k}_{₁}_{;j}_{₂}_{,k}_{₂} and β_{j,k}.

12. The method of claim 9, wherein the steps of calculating, preparing, sending, solving and updating are repeated until the predetermined thresholds withing the data batches and for the whole data set are satisfied.

13. A system for accelerating a machine learning training process, comprising:
a non-quantum computer that divides a set of data for training a machine learning model into a plurality of data batches, calculates a Jacobian matrix for each of the plurality of data batches, the Jacobian matrix and a loss vector being part of a linear matrix equation for updating a weight in the model, and arranges input data as a polynomial function formatted for a quantum computer; and
a quantum computer that solves a vector of weight updates; and
a computer module of the non-quantum computer for updating the weight in the model from the vector solved by the quantum computer.

14. The system of claim 13, wherein the computer module compares a norm of the residual for the updated weight in the model and a norm for a model weight in a step prior to updating the weight to determine whether a target condition is met.

15. The system of claim 13, wherein the non-quantum computer compares a global precision condition for all data and an output of the condition to determine whether the training of the machine learning model is complete.

16. The system of claim 15, wherein if the global precision condition is not reached, then the batches are reshuffled based on ranking.

17. The system of claim 15, wherein the non-quantum computer ranks the batches in an order of decreasing global loss.

18. The system of claim 13, wherein the quantum computer is at least one of an annealing quantum computer and a general-purpose computer.

19. The system of claim 13, wherein the non-quantum computer comprises a preparation module that prepares the input data for the quantum computer to solve a linear matrix equation to update weights in the model.

20. The system of claim 13, wherein the non-quantum computer comprises a preparation module that prepares the input data for the quantum computer to solve a matrix equation: J·S=−F(w) for the Jacobian matrix.
